(19) United States
(12) Patent Application Publication
(10) Pub. No.: US 2004/0222030 A1
(43) Pub. Date: Nov. 11, 2004

(54) Vehicle rear suspension support assembly with integrated electric drive

(75) Inventors: Norman Szalony, Brighton, MI (US); Scott K. Hanba, Redford, MI (US); Craig V. Sutton, South Lyon, MI (US)

Correspondence Address: Hugo A. Delevie, Esq., BRINKS HOFER GILSON & LIONE, P.O. Box 10395, Chicago, IL, 60610, US

(73) Assignee: Visteon Global Technologies, Inc.

(21) Appl. No.: 10/435,585

(22) Filed: May 9, 2003

(51) Int. Cl. B62D 21/00

(52) U.S. Cl. 180/311

(57) ABSTRACT

A support assembly for an independent rear suspension includes a generally-tubular central member having first end and a second end. A U-shaped end member is coupled to each end of the central member, such that the end members are structurally bridged by the central member. Lands defined on the ends of the arms of each end member are adapted to engage the vehicle frame rails through suitable isolation mounts. An attachment point defined on each end member is adapted to pivotally support a lateral link coupling a respective wheelend assembly to the support assembly. The central member advantageously defines at least a portion of a housing adapted to receive a driveline component, such as an electric motor, coupled to the vehicle's rear wheelend assemblies by a pair of shafts extending from the central member, with the further benefit that the shared suspension and driveline isolation mounts providing enhanced NVH characteristics.

### FIELD OF INVENTION

The invention relates to an independent rear suspension for a motor vehicle, wherein the vehicle includes a vehicle chassis or frame having a pair of spaced, generally-longitudinally-extending frame rails.

### BACKGROUND OF THE INVENTION

The prior art teaches an independent rear suspension for a motor vehicle in which a continuous, typically cast or stamped crossmember of a subframe assembly is bolted at each end to a respective frame rail through a first set of isolation mounts. One or more control arms, pivotally mounted on a respective portion of the crossmember, support a respective rear wheelend assembly relative to the vehicle chassis, whereby the wheelend assembly is positioned at a respective wheel location on the vehicle.

When such a typical rear subframe assembly is adapted to accept an electric drive, as when the vehicle is to incorporate a hybrid powerplant, the electric drive is typically bolted onto a center portion of the subframe assembly, such as the center portion of the assembly's continuous crossmember, through a dedicated set of isolation mounts. Such a configuration significantly increases the weight of the resulting subframe assembly, while further typically providing the subframe assembly with an increased vertical dimension that, in turn, triggers additional “packaging” design constraints.

Accordingly, what is needed is an independent rear suspension support assembly that is readily adapted to house an electric motor with which to drive a rear wheelend assembly that features a reduced assembly height and weight, and which features improved NVH performance, when compared to known rear suspension subframe designs.

### BRIEF SUMMARY OF THE INVENTION

In accordance with the invention, a support assembly for an independent rear suspension of a motor vehicle includes a central member having a first end and a second end, and a pair of end members, each end member being secured to a respective end of the central member such that the central member structurally “bridges” the two end members. A portion of each end member extends away from the central member to define a land adapted to engage a respective one of the vehicle's generally-longitudinally-extending frame rails proximate to a nominal rear wheel location of the vehicle. The support assembly further defines at least a pair of attachment points, each attachment point of being adapted to pivotally support a lateral link of connecting the support assembly to a respective one of the vehicle's rear wheelend assemblies to be supported by the support assembly relative to the vehicle.

While the invention contemplates a variety of configurations for the central member by which to provide a structural bridge between the end members, in an exemplary embodiment, the central member includes a tubular section formed, for example, of a rolled steel sheet or extruded aluminum alloy. By way of further example, in the exemplary embodiment, the tubular section of the central member has a generally elliptical cross-section to provide enhanced structural rigidity, with an attendant reduction in relative height and weight. When the supporting assembly of the invention is secured as by bolts to the frame rails, the tubular section of the central member preferably extends in a direction generally normal to the frame rails so as to readily receive a shaft through an end of the central member that is suitably coupled to a rear wheelend assembly of the vehicle.

Similarly, while the invention contemplates a variety of end configurations for each end member, by which each end of the central member is to be mounted onto a respective frame rail, in an exemplary embodiment, each end member is generally U-shaped, with a bight portion secured to a respective end of the central member. Each U-shaped end member of the exemplary embodiment further includes a pair of arms extending from the bight portion, with each arm including a land adapted to engage a respective generally-longitudinally-extending frame rail proximate to a nominal rear wheel location of the vehicle. One arm of each end member includes an attachment point defined on the arm between the rail-engaging land and the bight portion of the respective end member, the attachment point being adapted to pivotally support a lateral link connecting the arm to a respective rear wheelend assembly of the vehicle.

In accordance with another aspect of the invention, the central member of the support assembly defines at least a portion of a housing adapted to receive an electric motor that is supported, relative to the frame rails of the vehicle, solely by the central and end members of the support assembly. A shaft projecting from each end of the resulting housing is coupled, as through constant velocity joints of known configuration, to a hub of a respective one of the wheelend assemblies, such that the electric motor housed within the central member is operable to drive the wheelend assemblies. Isolation mounts disposed between the lands of the arms and the frame rails advantageously isolate both the rear suspension and the vehicle driveline to thereby enhance vehicle NVH performance.

In accordance with yet another aspect of the invention, the central member may advantageously house other types of driveline components, for example, an eddy-current retarder, that are adapted to be coupled as through constant velocity joints to either or both of the vehicle's rear wheelend assemblies while being supported, relative to the vehicle's frame rails, solely by the central and end members of the support assembly. Additional examples of driveline components which may be housed within the central member and supported, relative to the vehicle's frame rails, solely by the central and end members include mechanical geared axle components, such as a hypoid gear set and differential, and hydrostatic drive components.

In accordance with yet another aspect of the invention, the support assembly advantageously provides modular flexibility with respect to the selection of the central and end members, depending upon the static and dynamic loads to be applied to the support assembly when mounted on a given vehicle, the packaging constraints presented by the vehicle, and the driveline component(s), if any, selected to be housed within the support assembly's central member. In this manner, it will be appreciated that the invention greatly facilitates the manufacturability of vehicle lines featuring a variety of driveline and powertrain configurations, including those variants utilizing nondriven rear wheelend assemblies in which a central member of reduced dimension may advantageously employed.

In accordance with yet another aspect of the invention, the support assembly advantageously provides modular flexibility with respect to the location of attachment points for the lateral links coupling the supported wheelend assemblies to the support assembly. By way of example, by placing one or more attachment points for the collateral links on the end members of the support assembly, driveline components housed within central members of “standardized” dimension are readily adapted to vehicles utilizing different suspension geometries. Further, because the central member may be designed to bridge a substantial separating distance between the end members greater than that necessary to physically accommodate the housed driveline components, the invention advantageously accommodates an asymmetrical positioning of any driveline components housed within the central member so as to provide yet additional packaging flexibility vis-a-vis other adjacent vehicle components, for example, a fuel tank.

Additional features, benefits, and advantages of the invention will become apparent to those skilled in the art to which the invention relates from the subsequent description of an exemplary embodiment and the appended claims, taken in conjunction with the accompanying Drawings.

### BRIEF DESCRIPTION OF THE DRAWINGS

In the Drawings, wherein like reference numerals are used to designate like components in each of the several views:

FIG. 1 is a view in perspective of an exemplary support assembly for an independent rear suspension of a motor vehicle having generally-longitudinally-extending frame rails, wherein the support assembly's central member houses an electric drive;

FIG. 2 is a top view of the exemplary support assembly of FIG. 1, partially broken away to show the electric motor housed within the support assembly's central member;

FIG. 3 is a bottom view of the exemplary support assembly, further illustrating the attachment points adapted to pivotally support lateral links connected to each wheelend assembly; and

FIG. 4 is another view in perspective of the exemplary support assembly.

### DETAILED DESCRIPTION OF THE INVENTION

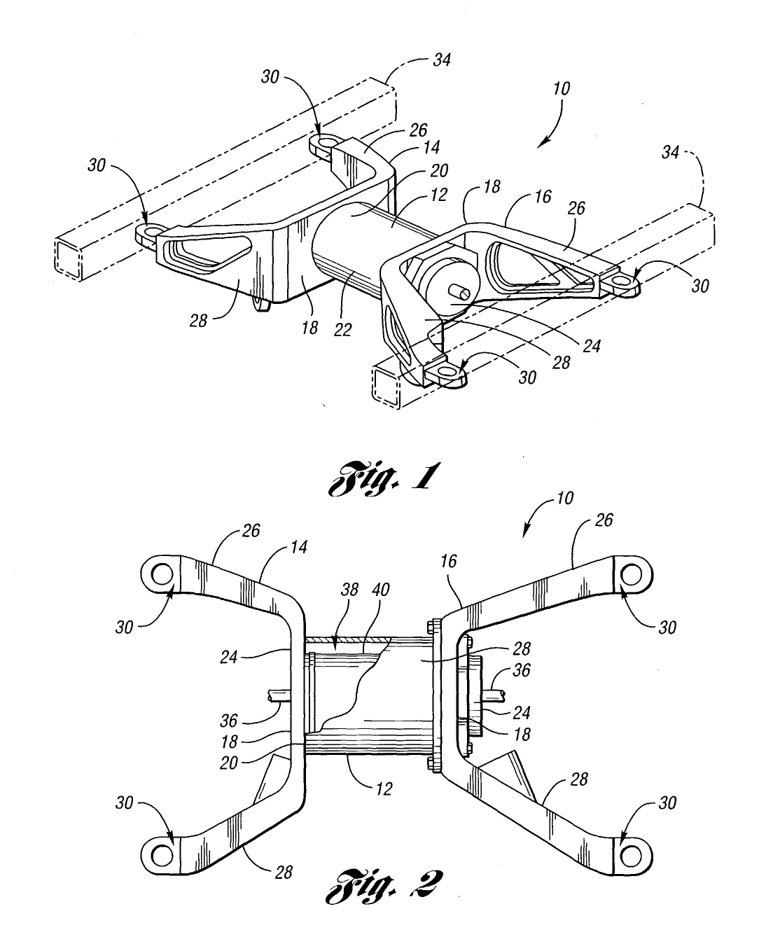

Referring to FIG. 1, an exemplary support assembly 10 for an independent rear suspension of a motor vehicle (not shown) includes an elongate, generally-tubular central member 12 that is conveniently formed of a rolled steel or aluminum alloy sheet stock. While the invention contemplates any suitable cross-sectional configuration for the central member 12 by which to provide the central member 12 with a desired structural rigidity, in the exemplary support assembly 10, the central member 12 has a generally elliptical cross-section that provides a desired strength and rigidity to the central portion of the support assembly 10 while further reducing the relative weight and height of the support assembly 10.

As best seen in FIGS. 1 and 2, a pair of generally U-shaped end members 14,16 formed, for example, of a machined aluminum casting, each include a bight portion 18 that is secured to a respective end 20,22 of the central member 12, for example, either permanently as by welding (as in the case of the first U-shaped member 14) or removably as by threaded fasteners (as in the case of the second U-shaped member 16). In this manner, the bight portions 18 of the U-shaped end members 14,16 conveniently define at least a portion of an end cap 24 closing the respective ends 20,22 of the central member 12.

Also referring to FIGS. 1 and 2, each U-shaped end member 14, 16 includes a pair of arms 26,28 which extend from the bight portion 18 in a direction generally away from the central member 12. Each arm 26,28 includes a land 30, preferably located on the distal end of the arm 26,28, adapted to engage a respective generally-longitudinally-extending frame rail 34 of the vehicle, as illustrated in FIG. 1. When the supporting assembly 10 is secured as by bolts (not shown) to the frame rails 34 of the vehicle, the central member 12 extends in a direction generally normal to the frame rails 34 so as to readily accommodate a shaft 36 extending through each end cap 24 on the central member 12.

More specifically, as best seen in FIG. 2, the central member 12 of the support assembly 10 defines a housing 38 adapted to receive and support an electric motor 40, the respective output shafts 36 of which extend through the respective end caps 24 on the central member 12 to drive each of the vehicle's rear wheelend assemblies through suitable constant velocity joint connections (not shown).

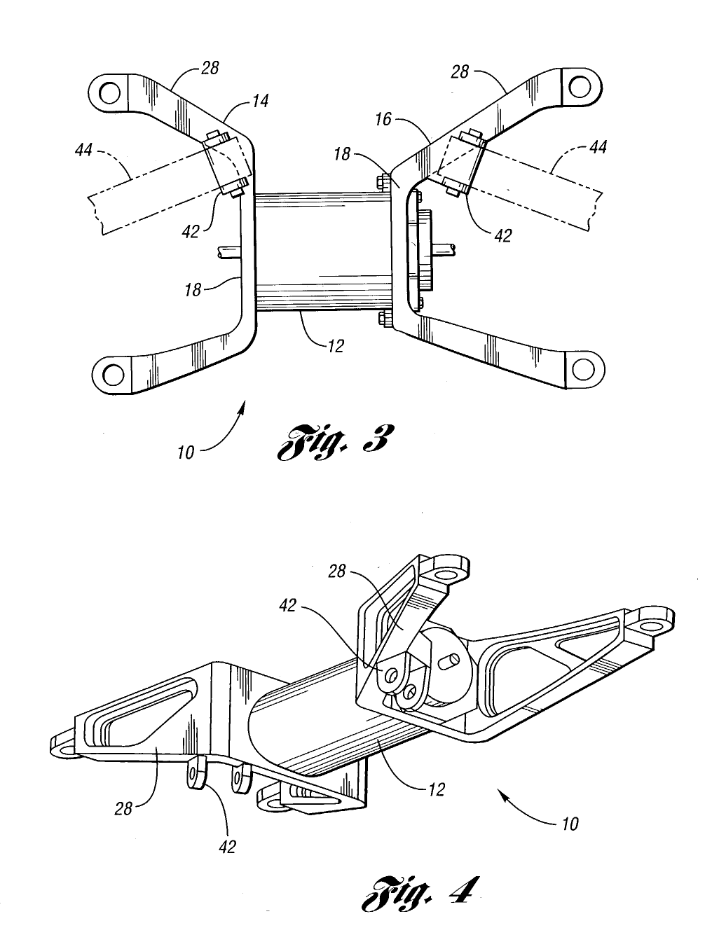

As best seen in FIGS. 3 and 4, one arm 28 of each U-shaped end member 14,16 further includes an attachment point 42 located on the arm 28 between the arm's rail-engaging land and the end member's bight portion 18. The attachment point 42 on the arm 28 is adapted to support a lateral link 44 connecting the arm 28 to a respective rear wheelend assembly.

Referring again to FIG. 1, in accordance with an aspect of the invention, the electric motor 40 housed within the central member 12 of the support assembly 10 is supported relative to the frame rails 34 of the vehicle solely by the central member 12 and U-shaped end members 14,16 of the support assembly 10. It will be appreciated that a suitable isolation mount (not shown) disposed between the frame rails 34 and the corresponding rail-engaging land 30 of each arm 26,28 of the U-shaped end members 14,16 advantageously serves to isolate both the lateral link of the rear suspension and the electric drive, thereby enhancing vehicle NVH levels.

While the above description constitutes the preferred embodiment, it will be appreciated that the invention is susceptible to modification, variation and change without departing from the proper scope and fair meaning of the subjoined claims. For example, while an the electric motor housed within the central member is illustrated in FIG. 2 as a self-sufficient electric motor with an integrated case, it will be appreciated that the housing defined by the central member and the bight portions of the end members can itself form the external case of the motor, providing suitable locations for the motor armature, brushes and shaft bearings. The invention further contemplates locating an electrical interface between the electric motor and the vehicle's electrical system within the housing defined by the central and end members of the support assembly.

1. A support assembly for an independent rear suspension of a vehicle, wherein the vehicle includes a chassis featuring rails extending generally longitudinally along either side of the vehicle, each rail being proximate to a nominal rear wheel location of the vehicle at which a respective wheelend assembly is to be supported, the support assembly comprising:
a central member having a first end and a second end; and
a pair of end members, each end member being secured to a respective end of the central member such that the central member forms a structural bridge between the end members, each end member extending away from the central member and defining at least one land adapted to engage a respective rail,
wherein one of the end members and the central member defines a pair of attachment points, each attachment point being adapted to pivotally support a lateral link connecting the supporting assembly to a respective one of the wheelend assembles.

2. The support assembly of claim 1, wherein each end member is generally U-shaped and includes a pair of arms separated by a bight portion, the bight portion being secured to the central member, and the at least one land being defined on the arms.

3. The support assembly of claim 2, wherein the respective bight portions of the end members cover at least a portion of the ends of the central member, respectively.

4. The support assembly of claim 2, wherein one of the first pair of attachment points is defined on one first arm of one end member between the land of the first arm and the bight portion.

5. The support assembly of claim 1, wherein the central member is adapted to house a driveline component, the driveline component being coupled to a shaft extending from the central member toward one of the wheelend assemblies.

6. The support assembly of claim 5, wherein the driveline component is an electric motor.

7. A support assembly for an independent rear suspension of a vehicle, wherein the vehicle includes a chassis featuring rails extending generally longitudinally along either side of the vehicle, each rail being proximate to a nominal rear wheel location of the vehicle at which a respective wheelend assembly is to be supported, the support assembly comprising:
a central member having a first end and a second end, and
a pair of end members, each end member being secured to a respective end of the central member such that the end members are bridged by the central member, each end member including a first arm extending away from the central member and having a land adapted to engage a respective rail, the first arm defining an attachment point adapted to pivotally support a lateral link connecting the arm to a respective wheelend assembly.

8. The support assembly of claim 7, wherein the central member includes a generally tubular section extending in a direction generally normal to the rails.

9. The support assembly of claim 8, wherein the generally tubular section of the central member has a generally elliptical cross-section.

10. The support assembly of claim 7, wherein each end member is generally U-shaped and includes a second arm separated from the first arm by a bight portion, the second arm extending away from the central member and including a land adapted to engage a respective rail.

11. The support assembly of claim 10, wherein one attachment point is defined on the first arm of one of the end members between the land of the first arm and the bight portion.

12. The support assembly of claim 10, wherein the bight portion of one end member covers at least a portion of the first end of the central member.

13. The support assembly of claim 7, wherein the central member is adapted to house a driveline component, the driveline component being coupled to a shaft extending from the central member toward one of the wheelend assemblies.

14. The support assembly of claim 13, wherein one end member forms at least a portion of an end cap on the central member; and wherein the shaft extends through a portion of the end cap.

15. The support assembly of claim 13, wherein the driveline component is an electric motor.

16. A support assembly for an independent rear suspension of a vehicle, wherein the vehicle includes a chassis featuring a pair of spaced, generally-longitudinally-extending rails, each rail extending proximate to a respective rear wheel location on the vehicle at which a respective wheelend assembly is to be supported, the support assembly comprising:
a generally tubular central member having a first end and a second end, wherein the central member is adapted to house a driveline component, the driveline component being coupled to a shaft extending from the central member and adapted to be coupled to one of the wheelend assemblies;
a pair of end members, each end member being secured to a respective end of the central member such that the end members are structurally bridged by the central member, each end member including a first arm extending away from the central member, the first arm having a land adapted to respectively engage one of the rails; and
a pair of attachment points defined on one of the end members and the central member, each attachment point being adapted to pivotally support a respective lateral link connecting the support assembly to a respective one of the wheelend assemblies.

17. The support assembly of claim 16, wherein each attachment point is defined on the respective first arm of each end member.

18. The support assembly of claim 16, wherein the driveline component is an electric motor adapted to drive one of the wheelend assemblies.

19. The support assembly of claim 16, wherein one end member is U-shaped and includes a second arm separated from the first arm by a bight portion, the second arm extending away from the central member and including a land adapted to engage a respective rail; and wherein the bight portion of the one end member forms at least a portion of an end cap on the central member.
